(19) United States
(12) Patent Application Publication
(10) Pub. No.: US 2020/0070081 A1
(43) Pub. Date: Mar. 5, 2020

(54) MONITORING SERVO-VALVE FILTER ELEMENTS

(71) Applicant: Rolls-Royce Deutschland Ltd & Co KG, Blankenfelde-Mahlow (DE)

(72) Inventor: Heiko MIKAT, Berlin (DE)

(21) Appl. No.: 16/535,651

(22) Filed: Aug. 8, 2019

(30) Foreign Application Priority Data
Sep. 3, 2018 (DE) 10 2018 214 923.2

(51) Int. Cl. B01D 46/00; F16K 37/00; G01M 15/14; F02C 9/26; F02C 9/22

(52) U.S. Cl. CPC B01D 46/0086; F16K 37/0041; G01M 15/14; F05D 2260/80; F02C 9/22; B01D 2279/60; F05D 2220/32; F02C 9/26

(57) ABSTRACT

A method for determining a state of at least one filter element of at least one servo valve assembly of a gas turbine engine, includes the following steps: Acquiring, by means of a measuring device, a multiplicity of values of a control current of an electric actuator of the servo valve assembly at various points in time and/or in various time periods; and analysing, by means of an analysis device, the multiplicity of values, wherein a change in the control current over time is ascertained, and determining the state of the filter element on the basis of the change in the control current over time. In addition, a system for determining a state of at least one such filter element is made available.

This application claims priority to German Patent Application DE102018214923.2 filed Sep. 3, 2018, the entirety of which is incorporated by reference herein.

The present disclosure relates to a method according to Claim 1 and to a system according to Claim 9 for determining a state of at least one filter element of at least one server valve assembly of a gas turbine engine.

Filter elements in fluid systems, in particular in fuel systems, can successively become blocked by particles in the fluid, e.g. the fuel, in the course of time. This applies, in particular, to fine-mesh filter elements of server valves which are actuated by means of a pressurized fuel. Such filter elements or the entire servo valves can be replaced at regular maintenance intervals. However, if such a filter element already becomes blocked in advance to a predetermined extent which requires immediate replacement, its replacement can give rise to unplanned maintenance work. In particular in the case of gas turbine engines, unplanned maintenance work can give rise to undesired standing times, e.g. of an aircraft with such a gas turbine engine.

In modern gas turbine engines there is a trend toward ever higher power levels. With the power level, the waste heat of oil systems of such gas turbine engines also generally rises, and as a result the fuel temperatures rise. With rising fuel temperatures, the risk of the formation of particles in the fuel increases, which can in turn promote blockage of the filter elements.

The object of the present invention is to reduce or even avoid unplanned maintenance measures on filter elements.

According to one aspect, a method for determining a state of at least one filter element of at least one servo valve assembly of a gas turbine engine is made available. The method comprises the following steps: acquiring, by means of a measuring device, a multiplicity of values (in particular measured values) of a control current of an electric actuator of the servo valve assembly at various points in time and/or in various time periods; and analysing, by means of an analysis device, the multiplicity of values, wherein a change in the control current over time is ascertained, and determining the state of the filter element on the basis of the change in the control current over time.

Chronological trends in the control currents are therefore ascertained. In this way it is possible to define an optimized time for an exchange of the filter element or a servo valve assembly with the filter element, which time avoids unplanned maintenance measures. The method therefore permits monitoring (of the state) of servo valve filter elements. In addition it is possible to use the method to ascertain (indirectly) fuel properties, specifically in particular to ascertain whether a temperature-conditioned formation of particles occurs in the fuel. This is possible particularly early on the basis of the analysed trends. In reaction to the analysis, suitable maintenance measures for maintaining the availability of the gas turbine engine can be initiated in an optimized fashion.

At the various points in time and/or in the various time periods it is possible to ascertain each case a profile of the control current with respect to a measure of valve dynamics (in particular of an adjustment speed, of a travel distance and/or of an adjustment position) of a servo valve of the servo valve assembly. This permits trends to be ascertained particularly precisely.

During the analysis of the change in the control current over time, the change in the profile of the control current over time can then be ascertained.

The various points in time or time periods can be assigned to various flights of an aircraft with the gas turbine engine. The analysis takes place e.g. between two flights.

The various points in time or time periods each correspond to an acceleration maneuver, a continuous operating state or a state of operational readiness of the gas turbine engine. It is therefore also possible to ascertain trends for the control currents between situations which can be particularly well compared.

The analysis optionally comprises a prediction of a future state of the filter element. Such a prediction can be used to ascertain an (optimized) point in time for the replacement of the filter element or of the server valve.

The at least one server valve assembly comprises in one refinement a servo valve which is configured to control a fuel supply of the gas turbine engine and/or a servo valve which is configured to control a setting of blades of the gas turbine engine.

The analysis can take place off-line, that is to say not in real time, in particular independently of an operating state of the gas turbine engine or when the gas turbine engine is switched off, e.g. when the aircraft is on the ground.

According to one aspect, a system for determining a state of at least one filter element of at least one servo valve assembly of a gas turbine engine is made available. The system comprises a measuring device which is configured to acquire a multiplicity of values (in particular measured values) of a control current of an electric actuator of the servo valve assembly at various points in time and/or in various time periods; and an analysis device which is configured to analyse the multiplicity of values, wherein a change in the control current over time can be ascertained with the analysis device in order to determine a state of the filter element, in particular with respect to a blockage.

The system can be configured to carry out the method according to any refinement described herein. Conversely, the method described herein can use a system according to any refinement which is described herein.

The system optionally comprises the servo valve assembly and/or the gas turbine engine.

The measuring device can be arranged at the gas turbine engine or on the aircraft, in particular can be permanently connected thereto.

The analysis device can be arranged spaced apart from the gas turbine engine and/or from the aircraft, in particular the gas turbine engine can be movable relative to the analysis device.

It is self-evident to a person skilled in the art that a feature or parameter described above in relation to one of the above aspects can be applied to any other aspect, unless these are mutually exclusive. Furthermore, any feature or any parameter described here may be applied to any aspect and/or combined with any other feature or parameter described here, unless these are mutually exclusive.

Embodiments will now be described by way of example, with reference to the figures, in which:

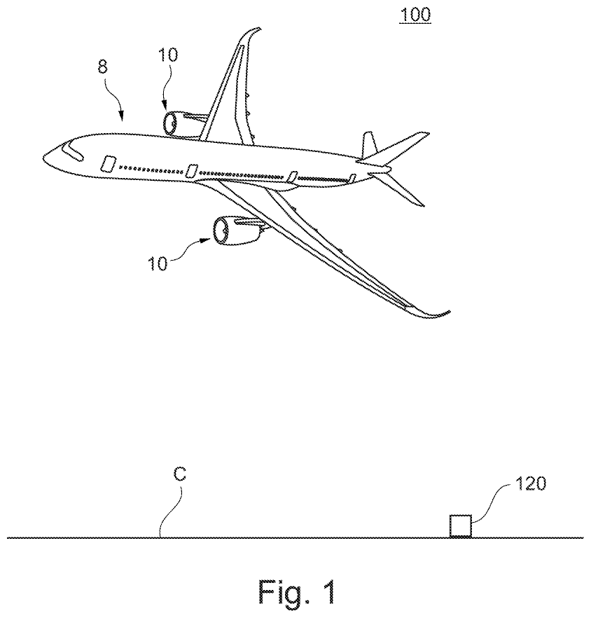

FIG. 1 shows a system with an aircraft with a plurality of gas turbine engines and an analysis device;

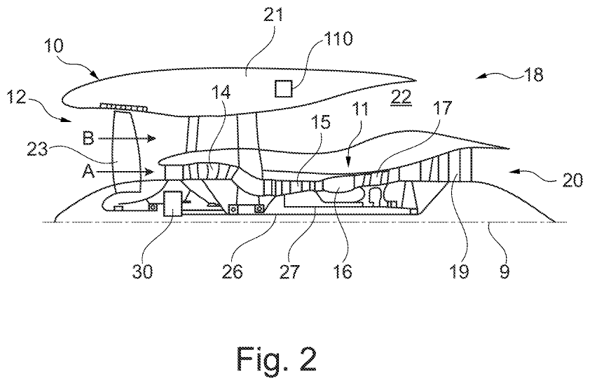

FIG. 2 shows a sectional side view of a gas turbine engine of the aircraft;

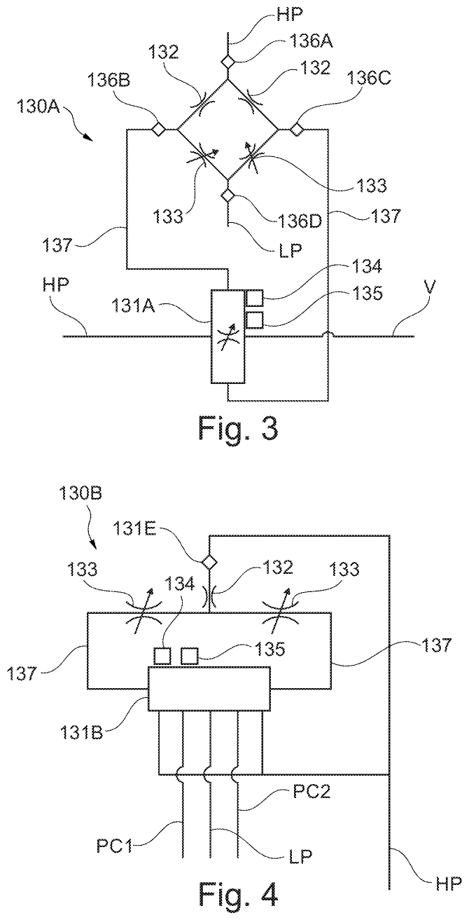

FIG. 3 shows a schematic illustration of a servo valve assembly for metering fuel;

FIG. 4 shows a schematic illustration of a servo valve assembly for adjusting stator blades of the gas turbine engine;

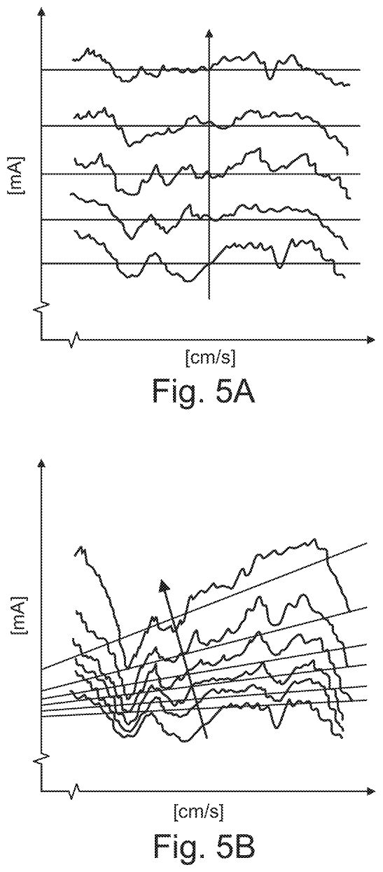

FIG. 5A shows a schematic illustration of the effects of an increasing asymmetrical blockage of a filter element;

FIG. 5B shows a schematic illustration of the effects of an increasing symmetrical blockage of a filter element;

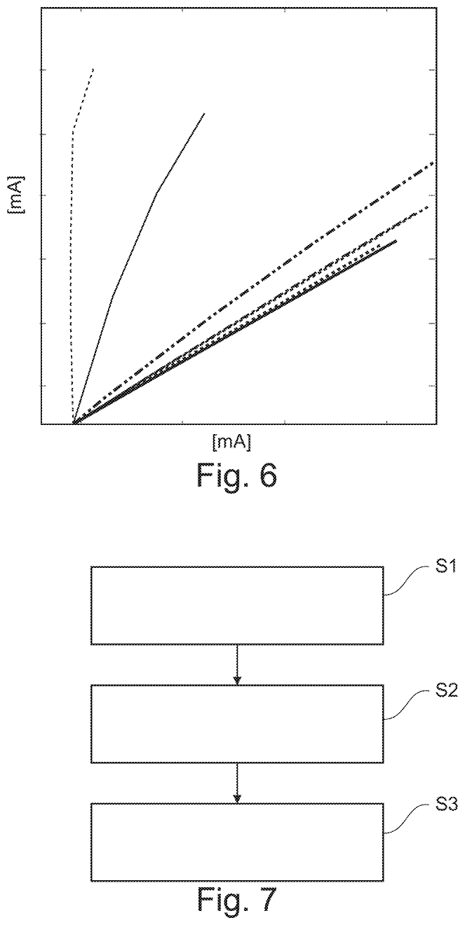

FIG. 6 shows a schematic illustration of the dependence on control currents with respect to various filter elements; and

FIG. 7 shows a schematic illustration of a method for determining a state of at least one filter element of at least one servo valve assembly of a gas turbine engine.

FIG. 1 shows a system 100 for determining a state of at least one filter element of at least one servo valve assembly of a gas turbine engine 10 of an aircraft 8, here in the form of a passenger aircraft. The aircraft 8 comprises at least one gas turbine engine 10, here a multiplicity thereof. In addition, the system 100 comprises a measuring device which is arranged at the gas turbine engine 10, a measuring device which is explained in more detail below, and an analysis device 120. The analysis device 120 is arranged on the ground. For example, the analysis device 120 is part of a central processor unit for evaluating flight data. The system 100 optionally comprises a multiplicity of gas turbine engines 10 and/or aircraft 8.

FIG. 2 illustrates the gas turbine engine 10 with a main rotational axis 9. The gas turbine engine 10 comprises an air intake 12 and a fan 23 that generates two airflows: a core airflow A and a bypass airflow B. The gas turbine engine 10 comprises a core 11 that receives the core airflow A. When viewed in the order corresponding to the axial direction of flow, the core engine 11 comprises a low pressure compressor 14, a high pressure compressor 15, a combustion device 16, a high pressure turbine 17, a low pressure turbine 19 and a core thrust nozzle 20. An engine nacelle 21 surrounds the gas turbine engine 10 and defines a bypass duct 22 and a bypass thrust nozzle 18. The bypass airflow B flows through the bypass duct 22. The fan 23 is attached to and driven by the low pressure turbine 19 via a shaft 26 and an (optional, e.g. epicyclic) planetary gearbox 30.

In operation, the core airflow A is accelerated and compressed by the low pressure compressor 14 and directed into the high pressure compressor 15 where further compression takes place. The compressed air exhausted from the high pressure compressor 15 is directed into the combustion device 16, where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high-pressure compressor 15 by means of a suitable connection shaft 27. The fan 23 generally is available the majority of the propulsive thrust. The (optional) planetary gearbox 30 is a reduction gearbox.

The quantity of fuel which is fed in per unit of time to the combustion device is set by a servo valve assembly 130A, which is not shown in FIG. 2 but rather is illustrated by means of FIG. 3.

The gas turbine engine 10 comprises one or more stator blade rings, each with a multiplicity of stator blades. The stator blade rings cannot rotate about the main rotational axis. The individual stator blades are pivotably mounted on a structure which is permanently connected e.g. to the engine nacelle 21. In order to pivot the stator blades, the gas turbine engine 10 comprises a servo valve assembly 130B, which is not shown in FIG. 2 but rather is illustrated by means of FIG. 4.

The gas turbine engine 10 also comprises a measuring device 110. The measuring device 110 is designed and provided for acquiring a multiplicity of values of a control current of an electric actuator of at least one servo valve assembly, in particular of the servo valve assembly 130A, 130B according to FIGS. 3 and/or 4, at various points in time and/or in various time periods.

The analysis device 120 (see FIG. 1) is designed and provided for analysing the multiplicity of values of the measuring device 110, in order to ascertain a change in the control current over time and to determine on the basis thereof a state of a filter element of the servo valve assembly.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of connecting shafts. By way of further example, the gas turbine engine shown in FIG. 2 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by an engine nacelle) or turboprop engine, for example.

The geometry of the gas turbine engine 10, and components thereof, is or are defined by a conventional axis system, comprising an axial direction (which is aligned with the rotational axis 9), a radial direction (in the bottom-to-top direction in FIG. 2), and a circumferential direction (perpendicular to the view in FIG. 2). The axial, radial and circumferential directions are mutually perpendicular.

FIG. 3 shows a servo valve assembly 130A of the gas turbine engine 10. The servo valve assembly 130A serves to control a fuel supply of the gas turbine engine 10 (as a fuel metering valve, FMV). The servo valve assembly 130A comprises a servo valve 131A. The servo valve 131A is e.g. an impingement baffle servo valve. The servo valve 131A is connected to a high-pressure fuel line HP and a supply line V of the gas turbine engine 10.

The servo valve 131A can be set by actuating an electric actuator 134 in the form of a torque motor in order to regulate the quantity of fuel which is input per unit of time from the high-pressure fuel line HP into the supply line V. The supply line V is connected to the combustion device 16, in order to supply it with fuel.

The servo valve 131A comprises two control inlets, to which pressurized fuel is applied via control lines 137. In addition, each control line 137 is connected (optionally via in each case one, e.g. adjustable valve 133 for calibration) to a common low-pressure fuel line LP, e.g. at a common junction according to FIG. 3. In addition, each control line 137 is connected (optionally via in each case one, e.g. adjustable valve 133 for calibration) to a common low-pressure fuel line LP, e.g. at a common junction according to FIG. 3.

In order to prevent particles from the fuel being able to enter the servo valve 131A, the servo valve assembly 130A comprises a plurality of (fine-mesh) filter elements. In this context, one filter element 136A (HP filter) is arranged in the common high-pressure fuel line HP. In each case one filter element 136B, 136C (servo-filter 1 and servo-filter 2) is arranged in each of the two control lines 137. A further filter element 136D (LP filter) is arranged in the common low-pressure fuel line LP.

During the operation of the gas turbine engine 10, the filter elements 136A-136D can filter particles out of the fuel. These particles can accumulate in the course of time on or in the filter elements 136A-136D and therefore impede the through-flow of fuel. As a result, the current which is necessary to reach a specific adjustment speed and/or to maintain a specific setting (e.g. the zero point setting) at the electric actuator 134 rises. If a filter element 136A-136D is blocked to a certain extent with particles, the function of the servo valve 131A could be adversely affected. Therefore, the filter elements 136A-136D are replaced in good time before this state is reached. The process of ascertaining an optimized point in time for the replacement will be described in more detail below.

Values of the control current which flows through the electric actuator 134 are acquired by means of the measuring device 110. For this purpose, the measuring device 110 is connected to the electric actuator 134. The measuring device 110 is e.g. the engine monitoring system (EMS) or part thereof, alternatively a unit which is different therefrom.

A sensor 135 measures the position, the travel distance and/or the adjustment speed of a piston of the servo valve 131A. The sensor 135 is also connected to the measuring device 110, so that the measuring device 110 can acquire values of the sensor 135 for the position, the travel distance and/or the adjustment speed.

FIG. 4 shows a further servo valve assembly 130B of the gas turbine engine 10. The servo valve assembly 130B serves to control an angular setting of stator blades of the gas turbine engine 10 (as a variable stator vane actuator VSVA). The servo valve assembly 130B comprises a servo valve 131B. The servo valve 131B is e.g. a two-stage impingement baffle servo valve. The servo valve 131B is connected to a high-pressure fuel line HP, a low-pressure fuel line LP and two output lines PC1, PC2 of the gas turbine engine 10.

The servo valve 131B can be set by actuating an electric actuator 134 in the form of a torque motor, in order to apply pressurized fuel to one or the other of the two output lines PC1, PC2. The output lines PC1, PC2 are connected to an adjustment mechanism of the stator blades, in order to pivot them optionally in one or the other rotational sense.

The servo valve 131B comprises two control inlets, to which pressurized fuel is applied via control lines 137. For this purpose, each control line 137 is connected (optionally via in each case one, e.g. adjustable valve 133 which can be adjusted for the purpose of calibration) to the high-pressure fuel line HP, e.g. at a common junction according to FIG. 4. In addition, an optional throttle valve 132 for generating a defined pressure state is arranged in the high-pressure fuel line HP.

In order to retain particles, one filter element 136E (HP filter) is arranged in the common high-pressure fuel line HP. A sensor 135 measures the position, the travel distance and/or the adjustment speed of a piston of the servo valve 131B. The sensor 135 and the electric actuator 134 are connected to the measuring device 110.

FIGS. 5A and 5B show schematically the control current of the electric actuator 134 of the servo valve 131A according to FIG. 3 which is necessary for reaching a specific adjustment speed (cm/s), in various states of a filter element of the servo valve assembly 130A. The control current is made available e.g. by the engine controller (Engine Electronic Controller, EEC).

FIG. 5A shows the control currents in various states of one of the filter elements 136B, 136C (servo-filter 1, servo-filter 2). It is therefore a case of asymmetrical blockage of the servo valve assembly 130A. In this context, the bottom curve represents a state without blockage. The bottom straight line represents a linear fit of the bottom curve. The curves which occur at relatively high currents and the associated straight lines correspond to states of the same filter element 136B or 136C when its blockage is increasing, illustrated by means of an indicated arrow.

FIG. 5B shows the control currents in various states of the filter element 136A (HP filter). It is therefore a case of symmetrical blockage of the servo valve assembly 130A. In this context, the bottom curve represents a state without blockage and therefore corresponds to the bottom curve in FIG. 5A. The bottom straight line represents again a linear fit of the bottom curve. Similarly to FIG. 5A, the curves which occur at relatively high currents and the associated curves correspond to states of the same filter element 136A when its blockage is increasing, illustrated again by means of an indicated arrow.

When FIGS. 5A and 5B are compared, it becomes clear that on the basis of the change in the dependence of the control current on the adjustment speed in the course of time it is possible to conclude which filter element of the servo valve assembly 130A, 130B is blocked.

An asymmetrical blockage gives rise to a displacement towards relatively high currents (e.g. corresponding to an addition of a constant which rises with the blockage). A symmetrical blockage gives rise to a relatively large gradient of the currents with the adjustment speed (e.g. corresponding to a multiplication by a constant which rises with the blockage).

Particularly good differentiation is possible by plotting (in particular averaged) control currents for the adjustment of the servo valve 130A (e.g. in the case of a maximum adjustment speed or in the case of another predefined adjustment speed) against the control current for maintaining the zero point setting.

FIG. 6 shows a corresponding illustration. Rising values along a line correspond here to an increasing blockage. The thin dashed line corresponds to the LP filter (symmetrical). The thin continuous line corresponds to the HP filter (symmetrical). The thick dot-dash line corresponds to a filter element (not shown in the figures) in the output line PC1 (asymmetrical). The other lines correspond to further asymmetrical states. It is apparent that asymmetrical blockages in this illustration differ significantly from symmetrical blockages.

An increasing blockage of one or more filter elements 136A-136E can be inferred on the basis of the change in the acquired values over time, in particular in the profile of the control system with respect to the adjustment speed.

This analysis of chronologically successive values is carried out by means of the analysis device 120. The analysis device 120 is designed to obtain the values of the control currents ascertained by the measuring device 110, and optionally the associated adjustment speeds, travel distances and/or adjustment positions. There may be provision here that the stationary analysis device 120 receives the ascertained values in each case after a flight of the aircraft 8, e.g. via a wire-connection, in a cableless fashion or by means of a physical data carrier. The analysis can therefore take place off-line, that is to say not in real time. This is possible because a blockage of the filter elements which is due to temperature-conditioned formation of particles in the fuel takes place over a relatively long time period.

The analysis device 120 is designed to ascertain a trend in the ascertained control currents. On the basis of the ascertained trend, the analysis device 120 can determine an optimum point in time for replacing one or more filter elements 136A-136E which achieves e.g. Minimum standing times of the aircraft 8, e.g. by virtue of the fact that a maintenance time which was planned in any case is selected. In addition, the analysis unit 120 is designed to ascertain, on the basis of the change in the dependence of the control current on the adjustment speed in the course of time, which filter element 136A-136E of the servo valve assembly 130A, 130B is blocked. Optionally, the analysis device 120 plots the control currents for the adjustment of the servo valve 130A, 130B against the control current for maintaining the zero point setting, in order to ascertain the state of one or more of the filter elements 136A-136E.

FIG. 7 shows a method for determining a state of at least one filter element 136A-136E of at least one servo valve assembly 130A, 130B of the gas turbine engine 10.

In a first step S1, in each case a multiplicity of values of the control current of the electric actuator 134 of the servo valve assembly 130A, 130B is acquired (in particular measured) by means of the measuring device 110 at various points in time and/or in various time periods. This can involve a servo valve assembly 130A, 130B according to FIG. 3 or 4, or alternatively another servo valve assembly of the gas turbine engine 10.

The various points in time or time periods can correspond to various, e.g. successive, flights of the aircraft 8 with the gas turbine engine 10, in particular in each case to an acceleration maneuver, continuous operating state or a state of the operational readiness of the gas turbine engine. Therefore, e.g. the characteristic control current profile for these various operating states can be ascertained during each flight, which permits a particularly precise comparison to be made.

In a second step S2, the values which are acquired by means of the measuring device 110 are transmitted to the analysis device 120, e.g. after the aircraft 8 has landed again after a flight.

In a third step S3, the multiplicity of acquired and transmitted values are analysed by means of the analysis device 120 in such a way that a change over time, in particular a trend of the control current, is ascertained, and a state of the filter element 136A-136E is determined on the basis of the change in the control current over time. In this context, the change over time, in particular the trend of the profile of the control current can be ascertained, e.g. as illustrated by means of FIG. 5A and FIG. 5B.

In this context, in each case a profile of the control current with respect to a measure of valve dynamics, specifically e.g. an adjustment speed and/or an adjustment position of the servo valve 131A, 131B of the servo valve assembly 130A, 130B can be ascertained. Alternatively or additionally, the control currents for the adjustment of the servo valve 130A, 130B are plotted against the control current for maintaining the zero point setting, in order to ascertain the state of one or more of the filter elements 136A-136E.

The analysis optionally comprises a prediction of a future state of the filter element 136A-136E and/or determination of a point in time for replacement of the filter element 136A-136E.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

### LIST OF REFERENCE SIGNS

8 Aircraft
9 Main rotational axis
10 Gas turbine engine
11 Core engine
12 Air intake
14 Low-pressure compressor
15 High-pressure compressor
16 Combustion device
17 High pressure turbine
18 Bypass thrust nozzle
19 Low pressure turbine
20 Core thrust nozzle
21 Engine nacelle
22 Bypass duct
23 Fan
26 Shaft
27 Interconnecting shaft
30 Gear box
100 System
110 Measuring device
120 Analysis device
130A, 130B Servo valve assembly
131A, 131B Servo valve
132 Throttle valve
133A-133D Adjustable valve
134 Electric actuator
135 Sensor
136A-136E Filter element
137 Control line
A Core airflow
B Bypass airflow
C Ground
HP High-pressure fuel line
LP Low-pressure fuel line
PC1, PC2 Output line
V Supply line

1. A method for determining a state of at least one filter element of at least one servo valve assembly of a gas turbine engine, comprising the following steps:
acquiring, by means of a measuring device, a multiplicity of values of a control current of an electric actuator of the servo valve assembly at various points in time and/or in various time periods; and
analysing, by means of an analysis device, the multiplicity of values, wherein a change in the control current over time is ascertained, and determining the state of the filter element on the basis of the change in the control current over time.

2. The method according to claim 1, wherein at the various points in time and/or in the various time periods in each case a profile of the control current with respect to a measure of valve dynamics, in particular of an adjustment speed of a servo valve of the servo valve assembly is ascertained.

3. The method according to claim 2, wherein during the analysis of the change in the control current over time, the change in the profile of the control current over time is ascertained.

4. The method according to claim 1, wherein the various points in time or time periods correspond to various flights of an aircraft with the gas turbine engine.

5. The method according to claim 1, wherein the various points in time or time periods each correspond to an acceleration maneuver, a continuous operating state or a state of operational readiness of the gas turbine engine.

6. The method according to claim 1, wherein the analysis comprises a prediction of a future state of the filter element.

7. The method according to claim 1, wherein the at least one servo valve assembly comprises a servo valve which is configured to control a fuel supply of the gas turbine engine and/or a servo valve which is configured to control a setting of blades of the gas turbine engine.

8. The method according to claim 1, wherein the analysis takes place off-line.

9. A system for determining a state of at least one filter element of at least one servo valve assembly of a gas turbine engine, comprising:
a measuring device for acquiring a multiplicity of values of a control current of an electric actuator of the servo valve assembly at various points in time and/or in various time periods; and
an analysis device for analysing the multiplicity of values, wherein a change in the control current over time can be ascertained with the analysis device in order to determine a state of the filter element.

10. The system according to claim 9, configured to carry out the method according to one of claim 1.

11. The system according to claim 9, comprising the servo valve assembly.

12. The system according to one of claim 9, comprising the gas turbine engine.

13. The system according to claim 11, wherein the measuring device is arranged at the gas turbine engine, in particular is permanently connected thereto.

14. The system according to claim 11, wherein the analysis device is arranged spaced apart from the gas turbine engine.

15. The system according to claim 13, wherein the gas turbine engine is movable relative to the analysis device.
